(19) United States
(12) Patent Application Publication
(10) Pub. No.: US 2024/0340504 A1
(43) Pub. Date: Oct. 10, 2024

(54) TELEVISION FOOD DETECTION

(71) Applicant: Sony Group Corporation, Tokyo (JP)

(72) Inventors: Marvin DeMerchant, San Diego, CA (US); Elizabeth Quepons, San Diego, CA (US)

(73) Assignee: Sony Group Corporation, Tokyo (JP)

(21) Appl. No.: 18/130,846

(22) Filed: Apr. 4, 2023

(51) Int. Cl. H04N 21/81; H04N 21/44; H04N 21/442

(52) U.S. Cl. CPC H04N 21/8133; H04N 21/44008; H04N 21/442

(57) ABSTRACT

Implementations generally relate to television viewing and food. In some implementations, a method includes detecting a cooking program being presented on a television. The method further includes extracting data associated with the cooking program. The method further includes identifying a food dish being prepared on the cooking program based on the data. The method further includes determining ingredients being used in the food dish based on the data. The method further includes determining a recipe of the food dish based on the data. The method further includes providing a name of the food dish, suggested ingredients of the food dish, and a suggested recipe of the food dish to a user.

### BACKGROUND

Cooking shows have gain much popularly as many consumers enjoy cooking and learning about new food recipes. Cooking shows or programs typically display and/or describe the needed ingredients for a given food dish, and a cook demonstrates preparation and cooking of the food dish. Some cooking programs may provide a website to users to view the recipe. The user may then modify and use recipe as desired.

### SUMMARY

Implementations generally relate to food. In some implementations, a system includes one or more processors, and includes logic encoded in one or more non-transitory computer-readable storage media for execution by the one or more processors. When executed, the logic is operable to cause the one or more processors to perform operations including: detecting a cooking program being presented on a television; extracting data associated with the cooking program; identifying a food dish being prepared on the cooking program based on the data; determining ingredients being used in the food dish based on the data; determining a recipe of the food dish based on the data; and providing a name of the food dish, suggested ingredients of the food dish, and a suggested recipe of the food dish to a user.

With further regard to the system, in some implementations, the extracted data includes metadata associated with the cooking program. In some implementations, the extracted data includes data based on image recognition. In some implementations, the extracted data includes data based on voice recognition. In some implementations, the logic when executed is further operable to cause the one or more processors to perform operations including: obtaining one or more user preferences; and modifying one or more of the ingredients based on the one or more user preferences. In some implementations, the logic when executed is further operable to cause the one or more processors to perform operations including: obtaining one or more user preferences; and modifying the recipe based on the one or more user preferences. In some implementations, the logic when executed is further operable to cause the one or more processors to perform operations including enabling the user to order the ingredients.

In some implementations, a non-transitory computer-readable storage medium with program instructions thereon is provided. When executed by one or more processors, the instructions are operable to cause the one or more processors to perform operations including: detecting a cooking program being presented on a television; extracting data associated with the cooking program; identifying a food dish being prepared on the cooking program based on the data; determining ingredients being used in the food dish based on the data; determining a recipe of the food dish based on the data; and providing a name of the food dish, suggested ingredients of the food dish, and a suggested recipe of the food dish to a user.

With further regard to the computer-readable storage medium, in some implementations, the extracted data includes data based on image recognition. In some implementations, the extracted data includes data based on voice recognition. In some implementations, the program instructions when executed are further operable to cause the one or more processors to perform operations including: obtaining one or more user preferences; and modifying one or more of the ingredients based on the one or more user preferences. In some implementations, the program instructions when executed are further operable to cause the one or more processors to perform operations including: obtaining one or more user preferences; and modifying the recipe based on the one or more user preferences. In some implementations, the program instructions when executed are further operable to cause the one or more processors to perform operations including enabling the user to order the ingredients.

In some implementations, a method includes: detecting a cooking program being presented on a television; extracting data associated with the cooking program; identifying a food dish being prepared on the cooking program based on the data; determining ingredients being used in the food dish based on the data; determining a recipe of the food dish based on the data; and providing a name of the food dish, suggested ingredients of the food dish, and a suggested recipe of the food dish to a user.

With further regard to the method, in some implementations the extracted data includes data based on image recognition. In some implementations, the extracted data includes data based on voice recognition. In some implementations, the method further includes: obtaining one or more user preferences; and modifying one or more of the ingredients based on the one or more user preferences. In some implementations, the method further includes: obtaining one or more user preferences; and modifying the recipe based on the one or more user preferences. In some implementations, the method further includes enabling the user to order the ingredients.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment providing food recipes, which may be used for implementations described herein.

FIG. 2 is an example flow diagram for providing food dish information, according to some implementations.

FIG. 3 is an example block diagram showing elements being presented on a cooking program, according to some implementations.

FIG. 4 is a block diagram of an example network environment, which may be used for some implementations described herein.

FIG. 5 is a block diagram of an example computer system, which may be used for some implementations described herein.

### DETAILED DESCRIPTION

Implementations generally relate to television viewing and food. Implementations improve a user's television experience of watching cooking shows on television (TV). Implementations may help a user with a food dish recipe, and may connect the user to an easy system for ordering the ingredients. In various implementations, the system improves a recipe by comparing the recipe to an artificial intelligence (AI) recipe database with the family food preferences. The system may, for example, replace ingredients for allergies and or similar dietary restrictions (e.g., being vegetarian, etc.). Implementations enable a user customer to enjoy eating meals that they watch on television by creating a library of favorite recipes that they can access as desired.

As described in more detail herein, in various implementations, a system detects a cooking program being presented on a television. The terms cooking program, program, cooking show, and show may be used interchangeably. The system further extracts data associated with the cooking program. The system further identifies a food dish being prepared on the cooking program based on the data. The system further determines ingredients being used in the food dish based on the data. The system further determines a recipe of the food dish based on the data. The system further provides a name of the food dish, suggested ingredients of the food dish, and a suggested recipe of the food dish to a user.

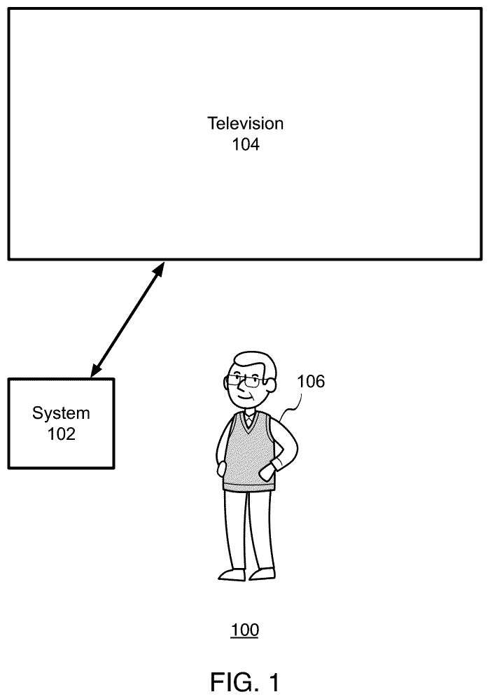

FIG. 1 is a block diagram of an example environment 100 providing food recipes, which may be used for implementations described herein. As shown, in various implementations, environment 100 includes a system 102 and a television 104. System 102 and television 104 may communicate directly via any suitable means such as a network (not shown) such as a Bluetooth network, a Wi-Fi network, etc. While system 102 and television 104 are shown separately, in some implementations, system 102 may be integrated with television 104.

In various implementations described herein, the cooking program may be delivered to the television 104 by any suitable means. For example, the cooking program may be sourced by a cable network, streaming from a video platform (e.g., YouTube, etc.), from a traditional television broadcast station, etc.

In various implementations, environment 100 may not have all of the components shown and/or may have other elements including other types of elements instead of, or in addition to, those shown herein. While system 102 performs implementations described herein, in other implementations, any suitable component or combination of components associated with system 102 or any suitable processor or processors associated with system 102 may facilitate performing the implementations described herein.

In various implementations, any neural networks and/or blockchain networks associated with system 102 may also facilitate performing the implementations described herein. For example, the system may perform various operations associated with implementations described herein using a neural network (not shown). The system may process any collected information through the neural network, which adapts or learns based on the collected information. The neural network may also be referred to as an artificial intelligence neural network or neural net. Example implementations directed to AI, machine learning, and neural networks are described in more detail herein.

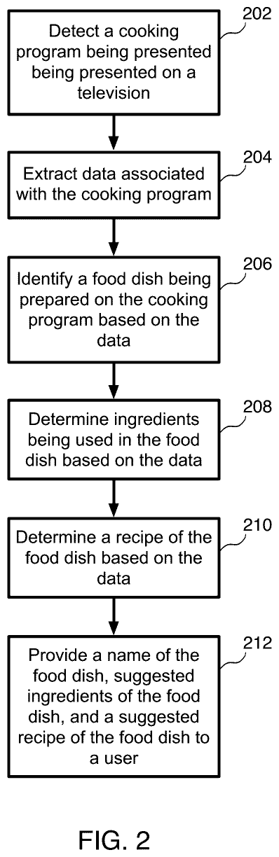

FIG. 2 is an example flow diagram for providing food dish information, according to some implementations. Referring to both FIGS. 1 and 2, a method is initiated at block 202, where a system such as system 102 detects a cooking program being presented on a television. In some implementations, the system may detect the cooking program in response to a user activating the system to detect food being prepared. The user may activate the system by voice, a television controller, a mobile device, mobile phones, smartphones, etc.

In various implementations, to detect the cooking program by determining that the television is on, determining the time, and mapping the channel to a schedule indicating that a cooking program (e.g., based on the title of the show/program or program segment or program episode, etc.) is being aired at that time. In some implementations, the system may employ techniques involving image recognition, voice recognition, and artificial intelligence (AI) to determine that a cooking program is being presented on the television.

At block 204, the system extracts data associated with the cooking program. In various implementations, the data may include metadata about the cooking program, metadata about the food dishes that are presented on the cooking program, etc.

In some implementations, the system may extract data automatically without user intervention. The system may also extract data based on a user command. For example, the user may indicate by voice that the user likes a particular food dish that is being currently presented. For example, the system may detect and recognize the user saying, “I like that dish,” “I want to cook that later,” etc. As such, the system may extract the data selectively.

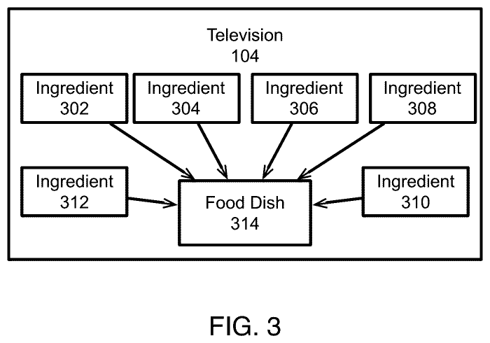

FIG. 3 is an example block diagram showing elements being presented in a cooking program, according to some implementations. As shown, a cooking program is being presented in television 104 of FIG. 1. Being presented on the cooking program are ingredients 302, 304, 306, 308, 310, 312, and food dish 314.

The system may extract data associated with these elements in a variety of techniques. For example, in various implementations, the extracted data includes metadata associated with the cooking program. The system may analyze metadata associated with the dish being prepared, where such metadata is obtained from the provider that is presenting the cooking program on television.

In various implementations, the extracted data includes data based on image recognition. For example, the system may use any suitable image recognition techniques to recognize food ingredients presented on the food program.

In various implementations, the extracted data includes data based on voice recognition. For example, the system may use any suitable voice recognition techniques to recognize spoken words and determine food ingredients, preparation steps, recipes, ingredient measurements, etc. mentioned on the food program.

At block 206, the system identifies a food dish being prepared on the cooking program based on the data. In some implementations, the system determines the name of a food dish. In various implementations, the system may determine the name of the dish from metadata associated with and delivered with the cooking program, or from using voice recognition techniques based on words spoken by the cook or presenter on the cooking program. In some implementations, the system may also determine from a food database common names and alternative names of the food dish. This enables the system to search its database and/or the internet for similar recipes of the food dish. The terms food, dish, and food dish may be used interchangeably. Food dishes may include beverages, as well.

At block 208, the system determines ingredients being used in the food dish based on the data. In some implementations, the system may obtain the ingredients based on metadata from the cooking program. In some implementations, the system may analyze the ingredients being used based on image recognition and voice recognition described herein.

At block 210, the system determines a recipe of the food dish based on the data. In some implementations, the system may obtain the recipe based on metadata from the cooking program. In some implementations, the system may analyze the ingredients being used based on image recognition and voice recognition described herein. For example, the system may detect, track, and record ingredients used, as well as cooking instructions such as the steps made in preparing and cooking the food dish.

At block 212, the system provides a name of the food dish, suggested ingredients of the food dish, and a suggested recipe of the food dish to a user. In some implementations, the system may also recommend complementary side dishes and/or beverages.

In various implementations, the system improves a recipe by tailoring the ingredients to suit the preferences of the user. The system may substitute ingredients accordingly. In some implementations, the system may compare the recipe of the food dish presented in the cooking program to recipes in an AI recipe database, where the recipe database may store food preferences of the user. The system may then make recipe recommendations based on the user preferences. For example, the system may replace ingredients for allergies and or similar diet restrictions (e.g., being vegetarian, etc.). The system may replace ingredients with gluten with those with no gluten per user preferences stored in a database.

In various implementations, the system may perform AI techniques to improve and/or fill in any missing ingredients or missing steps. The AI techniques compensate for any information gaps due to the system not always detecting the entire recipe (e.g., due to the user joining the program in progress, due to the presenter not speaking clearly, etc.).

In some implementations, the system may determine from the recipe database a number of people associated with the user. For example, the user may be living with a family. The system may make recommendations based on the number of people. For example, the system may adjust the amount of ingredients based on the number of portions specified.

As a result, implementations provide tailored recipes that comply with user or family food preferences, including dietary constraints such as likes/dislikes, allergies, etc. The system stores the name of the food dish, ingredients of the food dish, the recipe of the food dish as presented in the cooking program, and any one or more recommended recipes for the food dish in the recipe database. The system may compare such information to food dish information of any cooking program that is presented in the future.

In some implementations, the system may provide a set of recommended dishes for the user. The system may compare the food dish recipe to other recipes in the recipe database. These dishes may be of similar style and/or ingredients.

In various implementations, the system obtains one or more user preferences. In some implementations, the system modifies one or more of the ingredients based on the one or more user preferences. In some implementations, the system modifies the recipe based on the one or more user preferences.

In various implementations, the system enables the user to order the ingredients. For example, in some implementations, the system may add the ingredients to a shopping list. In some implementations, the shopping list may be a working or dynamic shopping list that includes ingredients for multiple food dishes of interest to the user. The system may connect the user to another system for ordering the ingredients of the recommended recipe. In some implementations, the system may receive an order for the ingredients from the user. The system may connect with an external system (e.g., an ingredients vendor, grocery delivery service, etc.), and then order the ingredients on behalf of the user. The external system may then send the ingredients to the user via any suitable delivery means.

In various implementations, the system enables the user to order the food dish from a restaurant. For example, there may scenarios where a user is not able to cook the food dish. This may be due to a lack of needed ingredients, lack of interest or confidence to cook the food dish. The system may provide recommendations for particular restaurants that serve the food dish. The system may also provide any comparisons of the particular dishes served by recommended restaurants. For example, the system may indicate if a given restaurant provides options or substitutes as to particular ingredients (e.g., organic, gluten free, etc.). The system may cause television 104 to display menus, food dish images, and prices.

In some implementations, the system may record the cooking program. This enables the user to rewatch the cooking program or portions of the cooking program. In various implementations, the system tracks where in the cooking program the dish is shown. This enables the user to more efficiently rewatch relevant portions of the cooking program.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

As indicated herein, in various implementations, the system may use artificial intelligence and machine learning techniques to perform operations associated with implementations described herein. In various implementations, the system may use a machine learning model to implement various artificial intelligence and machine learning techniques.

In various implementations, the system may use a set of collected data for a training set to create and train the machine learning model. The training set may include known data patterns and sequences, and known outcomes. The system repeatedly evaluates the machine learning model, which generates predictions based on collected data, and adjusts outcomes based upon the accuracy of the predictions. In some implementations, the machine learning model may learn through training by comparing predictions to known outcomes. As training progresses, the predictions of the machine learning model become increasingly accurate. In various implementations, the machine learning model may be based on various classification methods for time series analysis models such as random forest (RF), naïve model, exponential smoothing Model, autoregressive moving average (ARIMA), seasonal autoregressive moving average (SARIMA), linear regression, etc. In some implementations, the machine learning model may be based on machine learning methods such as multi-layer perceptron, recurrent neural network, and/or long short-term memory, etc. In various implementations, once training and setup are complete and evaluations become satisfactory, the machine learning model may function as a decision engine that can render determinations and decisions used by the system for carrying out implementations described herein.

Implementations described herein provide various benefits. For example, implementations improve a user's television experience of watching cooking shows on television (TV). Implementations described herein also assist a user with food dish recipes. Implementations also enable a user to connect systems for ordering the ingredients. Implementations also improve a recipe by comparing the recipe to an AI recipe database with food preferences of the user.

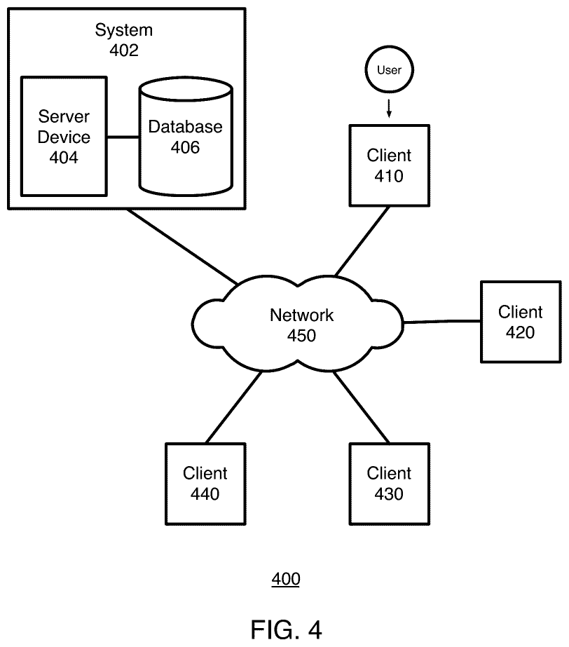

FIG. 4 is a block diagram of an example network environment 400, which may be used for some implementations described herein. In some implementations, network environment 400 includes a system 402, which includes a server device 404 and a database 406. For example, system 402 may be used to implement system 102 of FIG. 1, as well as to perform implementations described herein. Network environment 400 also includes client devices 410, 420, 430, and 440, which may communicate with system 402 and/or may communicate with each other directly or via system 402. Network environment 400 also includes a network 450 through which system 402 and client devices 410, 420, 430, and 440 communicate. Network 450 may be any suitable communication network such as a Wi-Fi network, Bluetooth network, the Internet, etc.

In various implementations, client device 410 may represent television 104 of FIG. 1. Clients 420, 430, and 440 may represent food ingredient vendors, restaurants, etc. Database 406 may represent any database or combination of databases described herein (e.g., recipe database, AI database, etc.).

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and network databases. Also, there may be any number of client devices. In other implementations, environment 400 may not have all of the components shown and/or may have other elements including other types of elements instead of, or in addition to, those shown herein.

While server device 404 of system 402 performs implementations described herein, in other implementations, any suitable component or combination of components associated with system 402 or any suitable processor or processors associated with system 402 may facilitate performing the implementations described herein.

In the various implementations described herein, a processor of system 402 and/or a processor of any client device 410, 420, 430, and 440 cause the elements described herein (e.g., information, etc.) to be displayed in a user interface on one or more display screens.

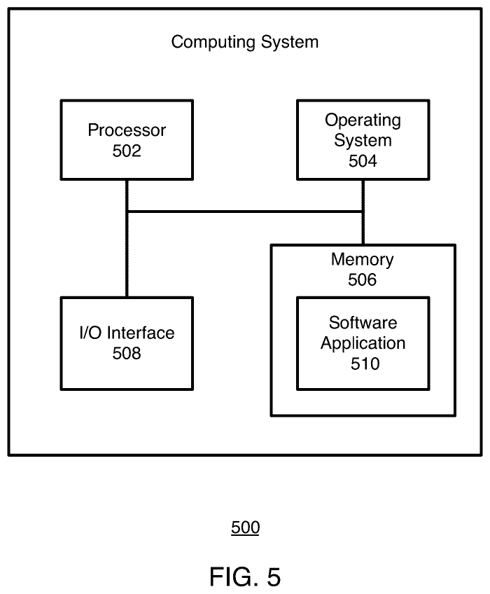

FIG. 5 is a block diagram of an example computer system 500, which may be used for some implementations described herein. For example, computer system 500 may be used to implement server device 404 of FIG. 4 and/or system 102 of FIG. 1, as well as to perform implementations described herein. In some implementations, computer system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of computer system 500 or any suitable processor or processors associated with computer system 500 or any suitable system may perform the steps described. Implementations described herein may be carried out on a user device, on a server, or a combination of both.

Computer system 500 also includes a software application 510, which may be stored on memory 506 or on any other suitable storage location or computer-readable medium. Software application 510 provides instructions that enable processor 502 to perform the implementations described herein and other functions. Software application may also include an engine such as a network engine for performing various functions associated with one or more networks and network communications. The components of computer system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computer system 500 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
detecting a cooking program being presented on a television;
extracting data associated with the cooking program;
identifying a food dish being prepared on the cooking program based on voice recognition and words spoken by a presenter on the cooking program;
determining ingredients being used in the food dish based on the data;
determining a recipe of the food dish based on the data; and
providing a name of the food dish, suggested ingredients of the food dish, and a suggested recipe of the food dish to a user.

2. The system of claim 1, wherein the extracted data comprises metadata associated with the cooking program.

3. The system of claim 1, wherein the extracted data comprises data based on image recognition.

4. The system of claim 1, wherein the extracted data comprises data based on voice recognition.

5. The system of claim 1, wherein the logic when executed is further operable to cause the one or more processors to perform operations comprising:
obtaining one or more user preferences; and
modifying one or more of the ingredients based on the one or more user preferences.

6. The system of claim 1, wherein the logic when executed is further operable to cause the one or more processors to perform operations comprising:
obtaining one or more user preferences; and
modifying the recipe based on the one or more user preferences.

7. The system of claim 1, wherein the logic when executed is further operable to cause the one or more processors to perform operations comprising enabling the user to order the ingredients.

8. A non-transitory computer-readable storage medium with program instructions stored thereon, the program instructions when executed by one or more processors are operable to cause the one or more processors to perform operations comprising:
detecting a cooking program being presented on a television;
extracting data associated with the cooking program;
identifying a food dish being prepared on the cooking program based on voice recognition and words spoken by a presenter on the cooking program;
determining ingredients being used in the food dish based on the data;
determining a recipe of the food dish based on the data; and
providing a name of the food dish, suggested ingredients of the food dish, and a suggested recipe of the food dish to a user.

9. The non-transitory computer-readable storage medium of claim 8, wherein the extracted data comprises metadata associated with the cooking program.

10. The non-transitory computer-readable storage medium of claim 8, wherein the extracted data comprises data based on image recognition.

11. The non-transitory computer-readable storage medium of claim 8, wherein the extracted data comprises data based on voice recognition.

12. The non-transitory computer-readable storage medium of claim 8, wherein the instructions when executed are further operable to cause the one or more processors to perform operations comprising:
obtaining one or more user preferences; and
modifying one or more of the ingredients based on the one or more user preferences.

13. The non-transitory computer-readable storage medium of claim 8, wherein the instructions when executed are further operable to cause the one or more processors to perform operations comprising:
obtaining one or more user preferences; and
modifying the recipe based on the one or more user preferences.

14. The non-transitory computer-readable storage medium of claim 8, wherein the instructions when executed are further operable to cause the one or more processors to perform operations comprising enabling the user to order the ingredients.

15. A computer-implemented method comprising:
detecting a cooking program being presented on a television;
extracting data associated with the cooking program;
identifying a food dish being prepared on the cooking program based on voice recognition and words spoken by a presenter on the cooking program;
determining ingredients being used in the food dish based on the data;
determining a recipe of the food dish based on the data; and
providing a name of the food dish, suggested ingredients of the food dish, and a suggested recipe of the food dish to a user.

16. The method of claim 15, wherein the extracted data comprises metadata associated with the cooking program.

17. The method of claim 15, wherein the extracted data comprises data based on image recognition.

18. The method of claim 15, wherein the extracted data comprises data based on voice recognition.

19. The method of claim 15, further comprising:
obtaining one or more user preferences; and
modifying one or more of the ingredients based on the one or more user preferences.

20. The method of claim 15, further comprising
obtaining one or more user preferences; and
modifying the recipe based on the one or more user preferences.
